(19) United States
(12) Patent Application Publication
(10) Pub. No.: US 2010/0205525 A1
(43) Pub. Date: Aug. 12, 2010

(54) Method for the automatic classification of a text with the aid of a computer system

(75) Inventor: Karsten Konrad, Saarbruecken (DE)

Correspondence Address: HARNESS, DICKEY & PIERCE, P.L.C., P.O. BOX 8910, RESTON, VA, 20195, US

(73) Assignee: Living-e AG

(21) Appl. No.: 12/656,450

(22) Filed: Jan. 29, 2010

(30) Foreign Application Priority Data
Jan. 30, 2009 (DE) 10 2009 006 857.0

(51) Int. Cl. G06F 17/27

(52) U.S. Cl. 715/256

(57) ABSTRACT

In one embodiment of the present invention, a method is disclosed for the automatic classification of a text contained in an incoming electronic information. At least one qualitative characteristic of at least one word of the text to be classified is determined and the frequency of occurrence of the qualitative characteristic in the text to be classified is also determined. The text to be classified is converted into a sequence of alphanumerical characters, the sequence of alphanumerical characters is dismantled in at least one specified way to form so-called character shingles, and the frequency of occurrence of the character shingle in the text to be classified is determined. A vector is formed from the qualitative characteristic and the associated frequency as well as from the character shingle and the associated frequency. The determined vector is then compared to vectors which are formed ahead of time with the aid of known example texts and in the same way, wherein each of the example texts is assigned to a class. The text to be classified is assigned in dependence of this comparison to one of the classes to which the example text is assigned.

The invention relates to a method for the automatic classification of a text with the aid of a computer system. The invention also relates to a computer program, a computer program product, and a computer system for the automatic classification of a text.

The document DE 102 10 553 B4 already discloses a method for classifying texts as follows: A plurality of example texts are selected which thematically match the expected texts to be classified. Classes are determined and the example texts are assigned to these classes. A table or a vector is then generated for each example text by determining the frequency of occurrence of specific qualitative characteristics of individual words in the text to be classified. The qualitative characteristics and the associated frequencies of occurrence in the respective text are stored in the table or the vector. A text to be classified is processed in the same way. The table or the vector for the text to be classified is then compared to the tables or the vectors of the example texts. The text to be classified is subsequently assigned to the class of the example text having a table or a vector that is closest to the table or vector of the text to be classified.

Texts contained in electronic information, meaning in particular texts of e-mails, frequently exhibit writing errors or writing variations. For example, the term “graphics card” in the technical jargon is oftentimes shortened into “Graka,” or English-language words are frequently used especially in connection with computer products, for example “Bluescreen” or “blue screen.” These types of writing errors or writing variations can lead to faulty classifications of an incoming e-mail.

It is therefore the object of the invention to improve the known method for the automatic classification of a text with the aid of a computer system.

This object is solved according to the invention with a method for the automatic classification of a text which consists of two parts. In a first part, at least one qualitative characteristic of at least one word of the text to be classified is determined and the frequency of occurrence of the qualitative characteristic in the text to be classified is determined. In a second part, the text to be classified is converted to a series of alpha-numerical characters, the series of alpha-numerical characters is then divided according to at least one predetermined manner into a so-called character shingle [display? tag?] and the frequency of occurrence of the character shingles in the text to be classified is determined. A vector is subsequently formed with the qualitative characteristic and the associated frequency, as well as the character shingle and its associated frequency. The determined vector is compared to vectors that were determined ahead of time with the aid of known example texts and in the same way, wherein each of the example texts is assigned to a class. In dependence on this comparison, the text to be classified is assigned to one of the classes to which the example texts are assigned.

According to the invention, a shingle process is thus used to automatically classify a text, wherein this measure allows the complete method to be used for correctly classifying even difficult texts. Writing errors or writing variations, which frequently occur especially in e-mails, also do not result in faulty classifications when using the method according to the invention. The method is therefore on the whole very robust and can be advantageously used especially with electronic information such as e-mails and the like.

Of particular importance is the realization of the method according to the invention in the form of a computer program that is intended for a computer system. The computer program comprises computer code that is suitable for realizing the method according to the invention when it is run on the computer system. The program code can furthermore be stored on a computer program product, for example on a disc or a compact disc (CD). In those cases, the invention is realized with the aid of the computer program or the computer program product, so that this computer program and the computer program product represent the invention in the same way as the method which they can suitably realize.

Additional features, options for use and advantages of the invention follow from the description below of exemplary embodiments of the invention as shown in the Figures of the drawing. All described or shown features by themselves or in any combination represent the subject matter of the invention, regardless of how they are combined in the patent claims or the references back, as well as independent of their formulation or representation in the specification and the drawing.

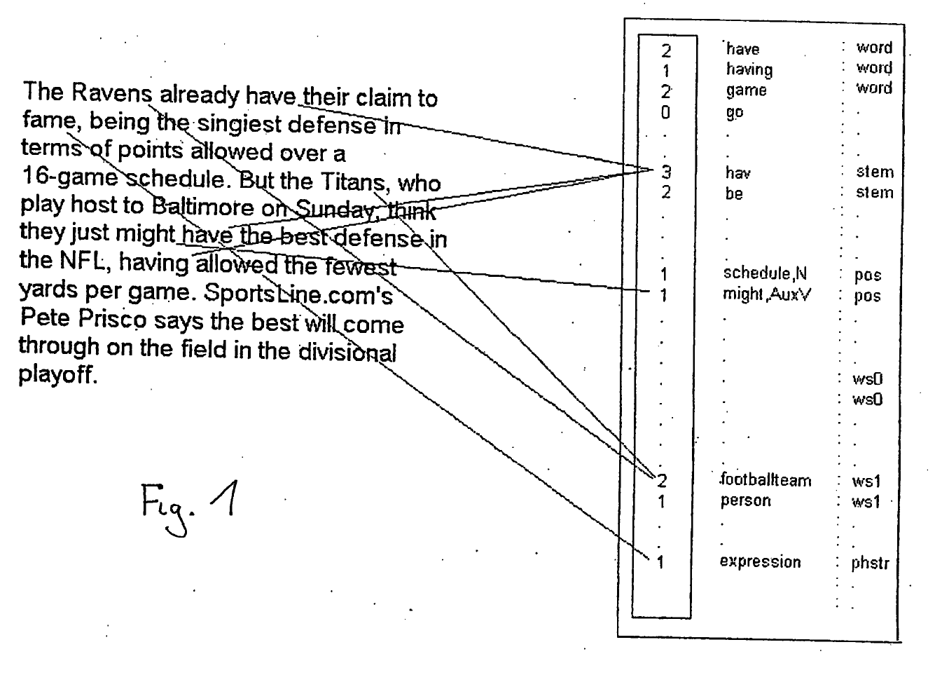

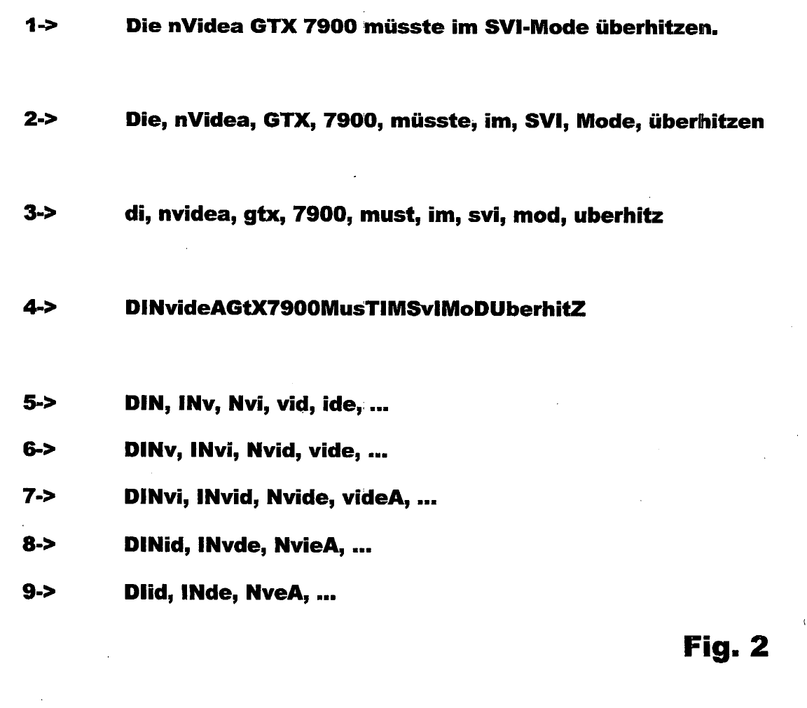

FIG. 1 shows a schematic block diagram and FIG. 2 shows the listing for an exemplary embodiment of a method according to the invention for classifying a text with the aid of a computer system.

Electronic information received by a company in optional ways, for example relating to client inquiries concerning products or services of the company, must be answered either automatically or forwarded to the respective expert in the field. Electronic information of this type relates to texts which are transmitted by electronic media, wherein these can include e-mails, SMS (short message service), or contributions to an Internet forum, or the information can be transmitted within a chat room.

For the processing of the electronic information, several classes are defined in a computer system, to which respectively at least one predetermined answer or a specific expert is assigned. The definition of the classes is dependent on the expected inquiries and thus, for example, on the products and services of the company. In dependence on these classes, example texts are created which make sense for the respective classes that are expected.

For example, it is possible to define classes which correspond to the products offered by the company, meaning the example texts consequently relate to these products.

Classes can furthermore also be defined which correspond to specific departments of the company. As a result, the example texts relate to these different departments. The individual example texts are subsequently assigned to the individual classes, wherein it must be taken into consideration that these are example texts which are known and thus can be assigned without problem to the classes because of their respective contents.

The actual text, which is not known ahead of time and is contained, for example, in an incoming e-mail or SMS, is automatically assigned by the computer system to one of the predetermined classes. In dependence on this classification, the e-mail or SMS is then answered automatically or forwarded to the expert in charge of this class.

As mentioned in the above, classes must first be defined for the classification of a text. For this, numerous example texts are subjected to the following method that is realized with the aid of the computer system. The example texts relate to the expected inquiries mentioned in the above, which presumably will be received by the company, for example in connection with its products and services.

The method explained in the following essentially consists of two parts that are shown schematically in FIGS. 1 and 2. These two parts are basically independent of each other and can be implemented, for example, one after another by the computer system.

An example text is shown on the left side of FIG. 1, based on which the computer system generates the table shown on the right side of FIG. 1. For explanatory purposes, the example text relates to an English-language report.

An information bit is provided in the center of each line of the table, which relates to one or several of the words in the example text. To the right thereof, the characteristic of this information is indicated and on the left thereof, the frequency of occurrence of this information in the example text is shown.

A first characteristic is given with “word” in the table of FIG. 1, wherein this relates to the individual words of the example text as such. The different words are respectively provided directly as information in the individual lines of the table. Thus, the first line relates to the word “have” which occurs with a frequency of “2” in the example text. According to the second line, the word “having” occurs with a frequency of “1” in the example text. The word “game” again occurs twice, and so forth.

In this way, the complete example text is divided by the computer system into its individual words. The individual words are then stored in the table under the characteristic “word,” along with their respective frequency. Thus, only words which also occur identically in the example text can be stored under the characteristic “word.”

A second characteristic is listed under “stem” in the table of FIG. 1, wherein this characteristic relates to word stems of the individual words of the example text. The different word stems are respectively listed as characteristic in the individual lines of the table. The line containing the word stem “hav” therefore relates to the words “have” and “having.” This word stem occurs with the frequency “3” in the example text. The word stem “be” relates to the words “being” and “is” and “will” and the like and occurs in the example text with the frequency “2” and so forth.

The computer system again processes the complete example text in view of the existing word stems which are then stored in the table under the characteristic “stem,” along with the respective frequency. It is possible in that case that the word stem stored in the table does not occur identically in the example text, for example the word stem “be” can occur only in the word form “will” in the example text.

A third characteristic is given as “pos” in the table in FIG. 1, wherein this refers to the part of speech. The characteristic “pos” therefore does not relate to the sentence, but only to the word. Thus, it follows from the first line, provided in the table for the characteristic “pos,” that the word “schedule” is a noun (N=noun in English). It follows from the second line relating to the characteristic “pos” that the word “might” is an auxiliary verb (AuxV=auxiliary verb in English).

The computer system processes the complete example text in view of existing parts of speech. These types of words are stored by the computer system in the table together with the frequency of occurrence. The above-described abbreviations mentioned as examples for the parts of speed are then added by the computer system to the individual words and are stored as information in the table. It is understood that corresponding abbreviations exist for other parts of speech as well.

Additional characteristics are listed in the table of FIG. 1 with “ws0,” “ws1,” “wsN,” wherein these are synonyms of words. These characteristics consequently do not relate to the sentence, but to the sense of a word.

The characteristics “ws0,” “ws1,” “wsN” differ with respect to the stage for the word ontology.

The characteristic “ws0” relates to synonyms for the same stage of the word ontology, for example including the synonyms “raining,” “pouring,” pouring heavily.”

The characteristic “ws1” relates to synonyms on a first, super-imposed stage of the word ontology. The first line, which includes the characteristic “ws1” in the table of FIG. 1, therefore contains the information “footballteam.” This information represents a synonym for two football teams specified in the example text, namely the “Ravens” and the “Titans.” The information “footballteam” is therefore a synonym on a first, super-imposed stage and occurs with the frequency of “2” in the example text. The second line that includes the characteristic “ws1” contains the information “person,” which represents a synonym for a person, namely the person “Pete Prisco” mentioned in the example text. The frequency of the information “person” is therefore “1.”

Additional synonyms on higher stages can be contained in the table under the characteristics “ws2,” “ws3” and to forth until “wsN.”

The complete example text is processed in this way by the computer system. A plurality of possible synonyms of different stages can thus be specified for the computer system, together with the associated information. The individual information bits are then stored by the computer system together with the frequency of occurrence.

A further characteristic is specified in the table of FIG. 1 with “phstr,” wherein this is sentence-related information and can indicate whether one or several words of the example text represent a noun phrase, a verb phrase or a participle phrase or the like. A noun phrase, for example, can be the expression “the gray moon,” a verb phrase can be the expression “shines yellow and green” and a participle phrase can be the expression “in the mighty sky.”

Also provided can be the information whether one or several of the words of the example text relate to a connected, idiomatic expression. Thus, the single line in the table of FIG. 1 that relates to the characteristic “phstr” can contain the information “expression” and relates to the words “claim to fame.” It means that these words represent a connected, idiomatic expression, namely the English expression “claim to fame.”

The computer system again processes the complete example text in view of the existing sentence-related information which is then stored in the table under the characteristic “phstr,” along with the respective frequency of occurrence. Stored as information is not only the respective type of sentence-related information, e.g. “expression,” but also those words to which the sentence-related information relates.

The following characteristics can furthermore also be stored in the table of FIG. 1:

The characteristic “vf”:

This characteristic indicates which other word a specific verb in the example text relates to. The specific verb and the other word of the example text are thus stored in the table as information together with the associated frequency of occurrence in the example text.

The characteristic “tr”:

This characteristic indicates “who” in a specific sentence does “what,” meaning it is stored in the table as information of who in the specific sentence has an active role and what the content of this role is.

Characteristic “kb”:

This characteristic indicates that a specific word of the example text is contained in an existing database. The database is set up ahead of time and contains, for example, all products of the company, meaning it is a product database. The word contained in the database and its frequency of occurrence in the example text is then stored as information in the table shown in FIG. 1.

Characteristic “da”:

This characteristic relates to other information, wherein this can be general semantic information and can be very detailed if applicable.

In summary, only the first characteristic “word” represents a quantitative criterion for classifying the example text. All other described characteristics are of a qualitative nature and always relate to the contents of the words or the sentences in the example text.

On the whole, a table such as the one shown in FIG. 1 is thus created for the present example text. This table represents a vector that characterizes the respective example text. The vector of a specific example text in this case contains a plurality of characteristics, associated information and associated frequencies as shown in the table in FIG. 1.

An example text is provided in the first line of FIG. 2 which is processed by the computer system over several stages into so-called character shingles, simply called shingles in the following.

The example texts shown in FIGS. 1 and 2 should match per se, so that in the final analysis a result vector is generated which characterizes this matching example text. We expressly point out that we deviate from this in the present case only for the purpose of explanation. The example text in FIG. 2 relates therefore to a graphics card for a computer and could, for example, be input as e-mail inquiry from a buyer or a user in the graphics card of the manufacturer.

In a first step, the complete text is dismantled by the computer system into alphanumerical character chains. These character chains for the most part consist of individual words or numbers. Special characters, such as blank spaces or line/paragraph breaks or sentence/word separating hyphens, are deleted by the computer system when creating the character chains. The individual alpha-numerical character chains are separated by specified characters, for example a comma or a blank space.

If this first step is applied to the example text in FIG. 2, the alphanumerical character chain can result which is shown in the second line of FIG. 2. We want to point out, for example, that the hyphen between the words “SVI-Mode” no longer exists in the resulting character chains shown in the second line and that the period at the end of the example text has also been removed.

In a second step, the complete text is standardized by the computer system with respect to lower case and upper case writing. It means that all alphanumerical chains resulting from the first step are written only in lower-case letters. That is to say, the capital letters used especially at the start of a word have been removed.

In a third step, specific characters of the character chain are replaced with other characters. This replacement depends on the language. In the German language, the following replacements could be made in the present example text: ä→a; ae→a; ü→u; ue→u; ö→o; oe→o; β→s, ss→s; ph→f and y→i.

Specific letters at the end of a word are furthermore also removed in the third step, wherein this removal is again dependent on the language. In the German language, for example, the following end letters can be removed in the example text: -s, -e, -e, -en.

Applying the second and the third step to the example text in FIG. 2 leads to the character chain in the third line of FIG. 2. As mentioned before, the third line no longer contains upper case letters and specific letters have been changed or deleted. Thus, the resulting character chain in the third line no longer contains the “-e” in the character chain “di” or the word “müsste [should]” has been changed to the character chain “must.” The same is true for the words “Mode [fashion]” and “überhitzen [overheat].”

In a fourth step, the complete text is encoded by the computer system in view of existing delimitations. The starting points in this case form the individual character chains which are successively present in the third line of FIG. 2. The still existing separation between the individual character chains, for example with the aid of a comma or a blank space, is now removed and replaced with a coding.

For the present example shown in FIG. 2, the individual delimitations are encoded by respectively using a capital letter for the first and last character of a character chain, wherein this coding is not used with numbers. The existing comma or blank space is then omitted, as previously mentioned. We want to point out that the generated capital letters have nothing to do with the known capitalization and use of lower case letters in words, but are used totally independent thereof for encoding the delimitation between successively occurring character chains.

With the example text in FIG. 2, this fourth step results in the sequence of alphanumerical characters shown in the fourth line of FIG. 2. The first two letters “D” and “I” are capitalized since they refer to the first and last characters of the character chain “di.” Correspondingly, the two letters “N” and “A” are capitalized as the first and last characters of the character chain “nvidea,” or the letters “U” and “Z” are capitalized because they are the first and last characters for the character chain “uberhitz.”

In a fifth step, the previously mentioned shingles are then generated by the computer system by dismantling the sequence of alphanumerical characters resulting from the fourth step in a specific, predetermined way.

In the case of 3-character shingles, three successively following characters of the aforementioned sequence are always combined by starting with the first, second and third character of the sequence and creating a first 3-character shingle. A second 3-character shingle is then created with the second, third and fourth character and this process is continued with a third, fourth and fifth character of the aforementioned sequence, and so forth. The resulting, succession of 3-character shingles is shown in the fifth line of FIG. 2.

With the 4-character shingles, four successive characters of the sequence of alphanumerical characters are always combined. The operational steps correspond to the ones explained in connection with the 3-character shingles. The resulting successive 4-character shingles are shown in line six of FIG. 2.

The 5-character shingles are shown in line seven of FIG. 2, wherein these are generated in the same way as explained for the 3-character and the 4-character shingles.

The so-called 3-1-2 character shingles are shown in line eight of FIG. 2. These are generated in that the computer system always selects three successively following characters of the sequence of alphanumerical characters shown in line four of FIG. 2, that a character in the sequence is then omitted, and that finally the next two characters are again selected. This is repeated in the same way as explained in connection with the 3-character shingles.

The same holds true for the 2-2-2 character shingles which are shown in the ninth line of FIG. 2. In this case, two characters are selected from the aforementioned sequence, two characters are then omitted, and two characters are again selected.

The shingles shown in lines five to nine of FIG. 2 are therefore all the result of step five. It is understood that other or additional shingles can also be generated by the computer system.

In step six, finally, all resulting shingles are then listed and the computer system determines an associated frequency of occurrence in the examined text for each of the existing shingles. The resulting table represents a vector that characterizes the example text. The vector of a specific example text in this case compries—as mentioned—a plurality of shingles with associated frequencies of occurrence.

Corresponding to the above explanations, two vectors now exist which characterize respectively one example text. Since this is the same example text, as previously mentioned, the two vectors characterize this matching example text.

The two vectors are combined into a single result vector. Since the matching example text is known, this result vector can be assigned to the class to which the existing, matching vector belongs. The result vector therefore characterizes not only the example text, but also the class to which the example text is assigned.

The above-explained determination of the result vector is then applied to a plurality of different example texts and the result vectors are assigned to the respective classes. The computer system in this way generates for each of the existing classes a great many result vectors belonging to the respective classes, which characterize these classes.

The complete operation described so far takes place prior to the actual classification of an actual text and is designed only to create a knowledge base upon which a decision can be made for a classification. This operation that takes place ahead of time is therefore also called a machine learning phase or an off-line phase. The subsequent classification of actual texts is referred thus referred to as on-line phase.

A text to be classified in the on-line phase is processed in the same way by the computer system as explained in connection with the example texts. Thus, a result vector is created for the actual text to be classified, as explained with the aid of FIGS. 1 and 2.

The result vector for the text to be classified is compared to the result vectors of the example texts. In dependence on this comparison, the actual text to be classified is assigned to one of the classes determined ahead of time.

This can take place in different ways.

With a first classification type, the so-called “lazy learning,” at least one class is assigned to each result vector of the example texts. Various result vectors can be assigned to the same classes. The new result vector of the text to be classified is then compared to all existing result vectors. The new result vector is assigned to the class which is assigned to the result vector of the example text that is closest to the new result vector.

With a second classification type, the so-called “support vector machine (SVM)” example texts that belong together and their associated result vectors are placed into a joint class. Delimitations between these classes are determined, so that each class occupies a delimited region of the total vector space. For the new result vector, it is then determined in which of these delimited regions the new result vector is located. The new result vector and thus the text to be classified are assigned to the class which corresponds to the region in which the new result vector is located.

With a third type of classification, the so-called “symbolic eager learning,” a decision tree or corresponding decision rules are created on the basis of the result vectors generated with the example texts. A specific class is assigned to each leaf of the decision tree. For the text to be classified, this decision tree must then be cycled through, in dependence of the newly generated result vector. The class to be assigned to the actual text to be classified is obtained as a result.

For a fourth type of classification, the so-called neuronal networks, the generated result vectors are subjected to mathematical operations which then allow drawing conclusions as to the respectively associated classes.

Independent of the selected type of classification, the computer system automatically draws a conclusion from the result vector generated for an actual text to be classified with respect to a specific class, to which the text to be classified is then assigned.

With the initially mentioned example of companies for which an automatic response to incoming e-mails is needed or where the e-mails should be forwarded to the respective expert, at least one predetermined response or a responsible expert is then assigned to each class. After the actual text of an incoming e-mail has been assigned automatically by the computer system to a specific class, it is thus possible to provide an automatic response to the e-mail or to forward it to the responsible expert.

The following changes or additions can be made in connection with the explained method:

The two parts of the method, described with the aid of FIGS. 1 and 2, can also be realized run at the same time. The two parts can furthermore be run on several computer systems.

When creating the vectors, a number can be assigned to each characteristic in accordance with the part of the method described in FIG. 1, and the vector to be created can be configured with the aid of these numbers. Accordingly, it is possible with the method part described with the aid of FIG. 2 to assign a number to each shingle and to use these numbers for configuring the vector to be created.

It is possible with both parts of the method that the various characteristics or the different shingles are weighted differently. For example, a higher weight can be assigned to specific shingles than is assigned to others. This different weighting can be realized, for example, by not only creating respectively one vector for each part, but by creating a separate vector in the described manner for all characteristics or shingles with the same weighting. The classification can respectively be achieved by comparing the vectors with the same weighting. A final classification can then be deduced from the result of these classifications using the weightings.

It is also possible that both parts of the described method are weighted differently and that a higher weight is assigned to the second part, explained with the aid of FIG. 2, than to the first part in FIG. 1. In that case, the two created vectors can each be classified separately and the result can then be processed with the aid of the weighting into a final classification.

A process can additionally be used for the second part of the explained method which allows determining the best possible combination of shingles. For example, a so-called meta-learning method such as “AdaBoost” can be used. With the aid of such a method, 4-character and 5-character shingles can then be combined into a new, separate classifier or 3-character shingles can be used only for the purpose of language identification.

1. A method for the automatic classification of a text that is contained in an incoming electronic information with the aid of a computer system, the method comprising:
determining at least one qualitative characteristic of at least one word of the text to be classified;
determining a frequency of occurrence of the at least one qualitative characteristic in the text to be classified;
converting the text to be classified to a sequence of alphanumerical characters;
dismantling the sequence of alphanumerical characters in at least one specified way into a character shingle;
determining a frequency of occurrence of the character shingle in the text to be classified;
determining a vector from the at least one qualitative characteristic and an associated frequency of occurrence, and the character shingle and the associated frequency of occurrence;
comparing the determined vector to previously determined vectors of known example texts that are determined in the same way, wherein each of the example texts is assigned to a class; and
assigning the text to be classified in dependence of the comparison to one of the classes to which the example texts are assigned.

2. The method according to claim 1, wherein during the conversion of the text to be classified into a sequence of alphanumerical characters, special characters are deleted.

3. The method according to claim 1, wherein during the conversion of the text to be classified into a sequence of alphanumerical characters, the capitalization is removed.

4. The method according to claim 1, wherein during the conversion of the text to be classified into a sequence of alphanumerical characters, specific characters are replaced with other characters.

5. The method according to claim 1, wherein during the conversion of the text to be classified into a sequence of alphanumerical characters, specific letters at the end of a word are removed.

6. The method according to claim 1, wherein during the conversion of the text to be classified into a sequence of alphanumerical characters, the complete text is encoded in view of existing delimitations.

7. The method according to claim 1, wherein following the dismantling of the sequence of alphanumerical characters to form a so-called character shingle, a number of successively following characters of the sequence are combined.

8. The method according to claims 7, wherein during the combining of successively following characters at least one character of the sequence is omitted.

9. The method according to claim 7, wherein the combining of successively following characters is realized across encoded delimitations of the text, if applicable.

10. The method according to claim 7, wherein a best possible combination of shingles is determined.

11. The method according to claim 1, wherein a weighting of the vectors is carried out.

12. A computer program with program code for realizing the method according to claim 1 if the program code is run on a computer system.

13. A computer program product with a program code that is stored on a machine-readable data carrier for realizing the method according to claim 1 if the program code of the computer program product is run on a computer system.

14. A computer system for the automatic classification of a text contained in an incoming electronic information, wherein a computer program according to claim 12 is present.

15. The method according to claim 2, wherein the special characters include at least one of blank spaces, line/paragraph breaks, and sentence/word separating hyphens.

16. The method according to claim 3, wherein the capitalization is removed at the start of a word.

17. The method according to claim 4, wherein the specific characters being replaced with other characters includes at least one of ä a; ae a; ü u; ue u; ö o; oe o; s; ss s; ph f and y i.

18. The method according to claim 5, wherein the specific letters at the end of a word being removed include at least one of -s, -e, -e, and -en.

19. The method according to claim 6, wherein the complete text being encoded in view of existing delimitations is done by capitalizing respectively the first and the last character of a character chain that corresponds to a word of the text.

20. A computer readable medium including program segments for, when executed on a computer device, causing the computer device to implement the method of claim 1.
